(19) United States
(12) Patent Application Publication
(10) Pub. No.: US 2013/0316684 A1
(43) Pub. Date: Nov. 28, 2013

(54) METHOD FOR PROVIDING PHONE BOOK SERVICE INCLUDING EMOTIONAL INFORMATION AND AN ELECTRONIC DEVICE THEREOF

(71) Applicant: SAMSUNG ELECTRONICS CO. LTD., Suwon-si (KR)

(72) Inventor: Dong-Hyun CHO, Suwon-si (KR)

(73) Assignee: SAMSUNG ELECTRONICS CO. LTD., Suwon-si (KR)

(21) Appl. No.: 13/900,169

(22) Filed: May 22, 2013

(30) Foreign Application Priority Data
May 23, 2012 (KR) 10-2012-0054820

(51) Int. Cl. H04W 4/16

(52) U.S. Cl. CPC H04W 4/16
USPC 455/415

(57) ABSTRACT

A method and an apparatus for providing a phone book service including emotional information are provided. The method for providing the phone book service including the emotional information includes receiving call data, detecting an emotion of another party using the received call data, and storing the emotion of the other party to phone book data of the other party of a phone book.

### PRIORITY

This application claims the benefit under 35 U.S.C. §119(a) of a Korean patent application filed on May 23, 2012 in the Korean Intellectual Property Office and assigned Serial No. 10-2012-0054820, the entire disclosure of which is hereby incorporated by reference.

### BACKGROUND OF THE INVENTION

1. Field of the Invention

The present invention relates to a method and an apparatus for controlling an electronic device. More particularly, the present invention relates to a method and an apparatus for providing a phone book service including emotional information in an electronic device.

2. Description of the Related Art

Recently, electronic devices such as mobile communication terminals and portable terminals are increasingly used. Accordingly, service providers competitively develop electronic devices having more convenient functions so as to secure more users.

Particularly, an electronic device including a communication function provides a phone book service to manage necessary phone numbers and information in relation to a user's business and private life. Information stored in the phone book may include names, photos, e-mails, phone numbers, addresses, anniversary dates, groups, and the like.

A user of an electronic device utilizes associated functions such as a calling function, a message function, and an e-mail function by retrieving the information stored in the phone book service. For example, the electronic device user searches for a phone number and then tries to call or send a message to the corresponding phone number. For example, the electronic device user may search for an e-mail address and send an e-mail to the corresponding e-mail address.

As discussed above, the electronic device user can utilize various associated functions through the information search in the phone book service. During the use of such functions and information search, it would be helpful for the user to be aware of emotional information relating to the information in the phone book service. Hence, the electronic device requires a user interface to enhance the utilization of the phone book service of the electronic device user.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly an aspect of the present invention is to provide an apparatus and a method for providing a phone book service including emotional information in an electronic device.

Another aspect of the present invention is to provide an apparatus and a method for detecting an emotion of the other party using video call data in an electronic device.

Yet another aspect of the present invention is to provide an apparatus and a method for detecting an emotion of the other party using voice call data in an electronic device.

In accordance with an aspect of the present invention, a method for providing a phone book service including emotional information is provided. The method includes receiving call data, detecting an emotion of another party using the received call data, and storing the emotion of the other party to phone book data of the other party in a phone book.

In accordance with another aspect of the present invention, an electronic device is provided. The electronic device includes one or more processors, a memory, and one or more programs stored in the memory and configured for execution by the one or more processors. The one or more programs include instructions for receiving call data, for detecting an emotion of another party using the received call data, and for storing the emotion of the other party to phone book data of the other party in a phone book.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of an electronic device according to an exemplary embodiment of the present invention;

FIG. 2 is a block diagram of a processor according to an exemplary embodiment of the present invention;

FIG. 3A is a flowchart of a method for storing emotional information in a phone book in an electronic device according to an exemplary embodiment of the present invention;

FIG. 3B is a diagram of an electronic device for storing emotional information in a phone book according to an exemplary embodiment of the present invention;

FIG. 4 is a flowchart of a method for storing emotional information in a phone book using video call data in an electronic device according to an exemplary embodiment of the present invention;

FIG. 5 is a flowchart of a method for storing emotional information in a phone book using video call data in an electronic device according to an exemplary embodiment of the present invention;

FIG. 6 is a flowchart of a method for storing emotional information in a phone book using video call data in an electronic device according to an exemplary embodiment of the present invention;

FIG. 7 is a flowchart of a method for storing emotional information in a phone book using voice call data in an electronic device according to an exemplary embodiment of the present invention;

FIG. 8 is a flowchart of a method for storing emotional information in a phone book using voice call data in an electronic device according to an exemplary embodiment of the present invention;

FIG. 9 is a flowchart of a method for storing emotional information in a phone book using voice call data in an electronic device according to an exemplary embodiment of the present invention;

FIG. 10 is a flowchart of a method for providing a phone book service in an electronic device according to an exemplary embodiment of the present invention;

FIG. 11 is a flowchart of a method for providing a phone book service in an electronic device according to an exemplary embodiment of the present invention;

FIGS. 12A and 12B are diagrams of screen configurations for providing a video call service in an electronic device according to exemplary embodiments of the present invention; and

FIGS. 13A-13C are diagrams of screen configurations for providing a phone book service in an electronic device according to exemplary embodiments of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide a technique for providing a phone book service including emotional information in an electronic device.

In the following description, the term “electronic device” encompasses a mobile communication terminal, a Personal Digital Assistant (PDA), a laptop, a smart phone, a netbook, a television, a Mobile Internet Device (MID), an Ultra Mobile Personal Computer (UMPC), a tablet PC, a navigation device, an MP3 player, and the like.

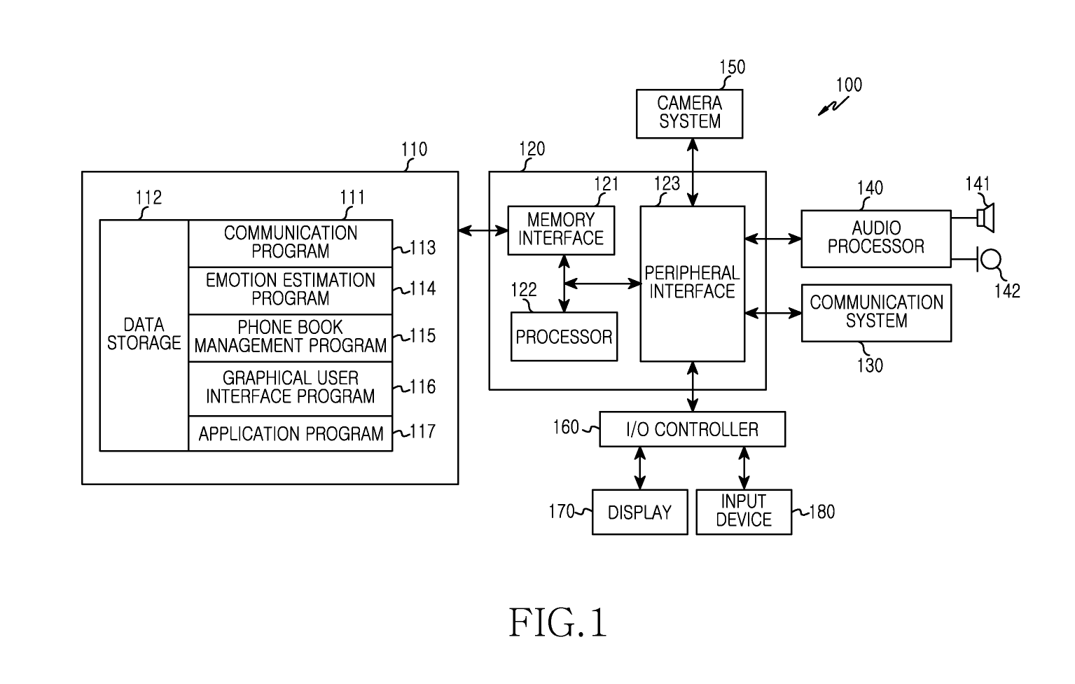

FIG. 1 is a block diagram of an electronic device according to an exemplary embodiment of the present invention.

Referring to FIG. 1, the electronic device 100 includes a memory 110, a processor unit 120, a communication system 130, an audio processor 140, a camera system 150, an Input/Output (I/O) controller 160, a display 170, and an input device 180. Herein, a plurality of memories 110 may be included.

The components are explained in more detail below.

The memory 110 includes a program storage 111 for storing a program to control operations of the electronic device 100, and a data storage 112 for storing data generated in the program execution. For example, the program storage 111 includes a communication program 113, an emotion estimation program 114, a phone book management program 115, a graphical user interface program 116, and at least one application program 117. Herein, the programs stored in the program storage 111 may each be represented as an instruction set which is a set of instructions. For example, the data storage 112 stores the phone book data which includes visual sample information, voice sample information, and emotional information of the other party. Herein, the visual sample information indicates data for detecting emotion based on a facial expression or characteristic of the other party which is recognized through a video call screen in the electronic device. The voice sample information indicates data for detecting emotion based on voice information of the other party which is recognized based on the voice call data in the electronic device.

The communication program 113 includes at least one software component for processing call data transmitted and received via the communication system 130.

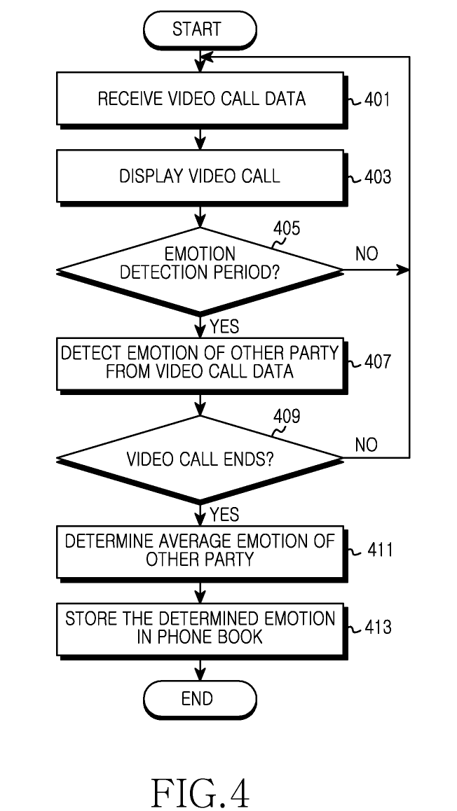

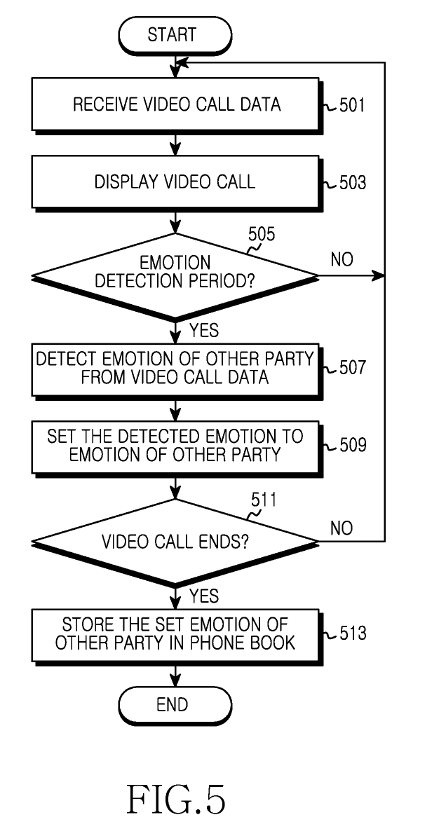

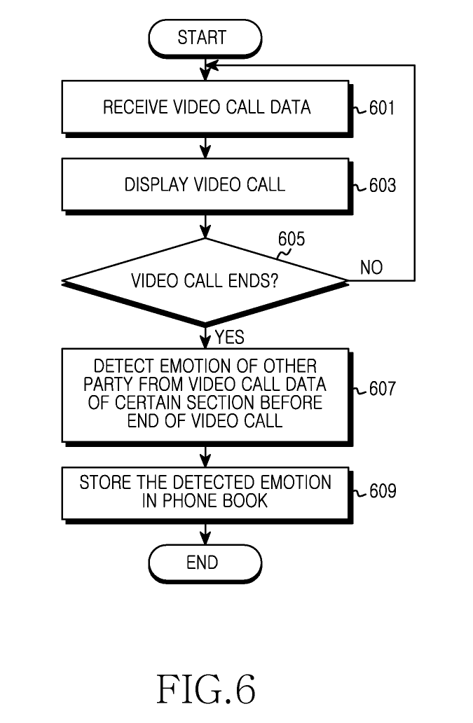

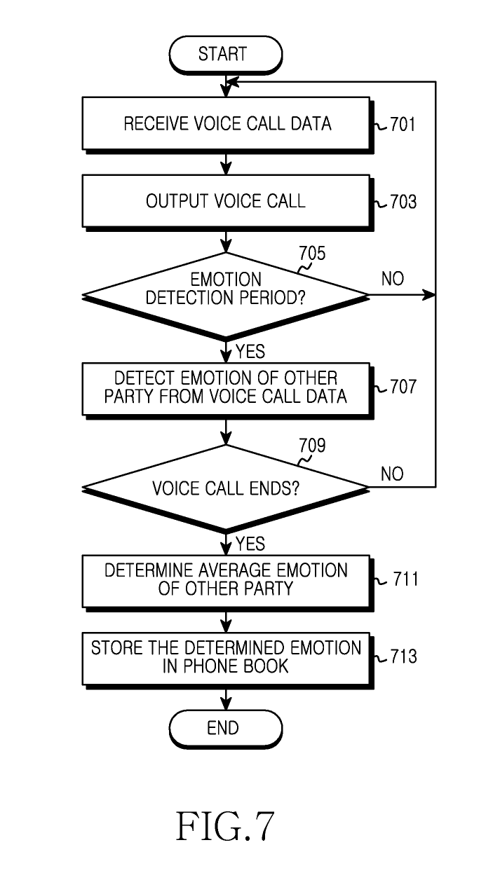

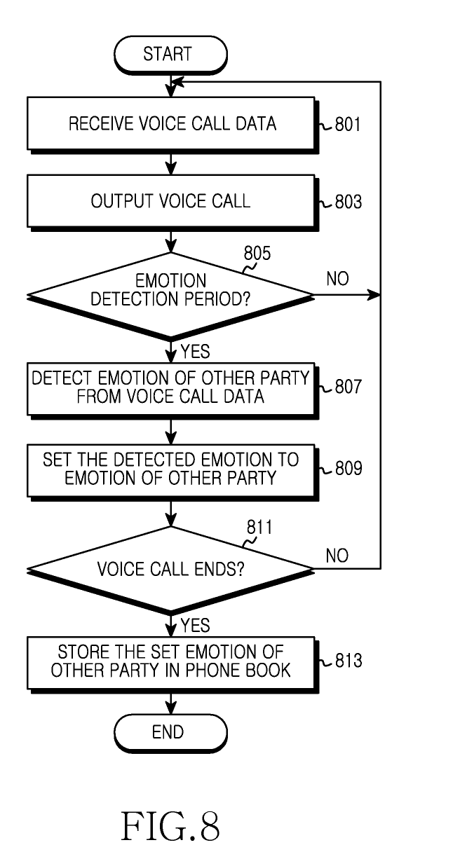

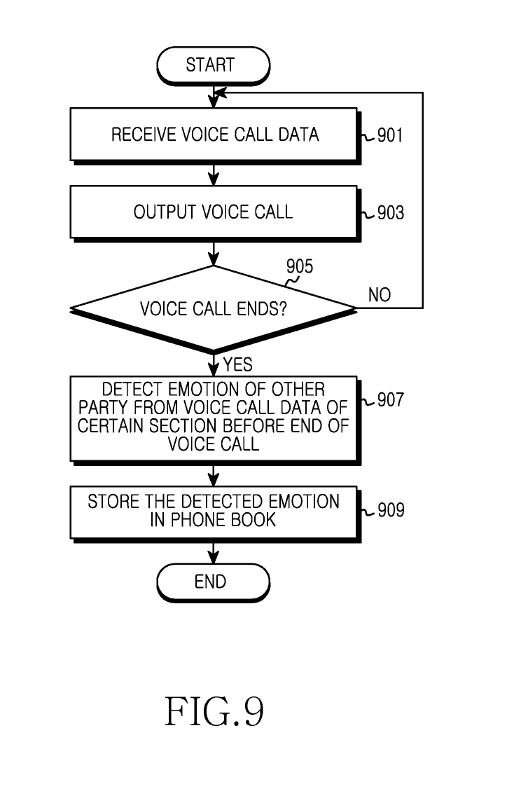

The emotion estimation program 114 includes at least one software component for detecting the emotion of the other party using the call data received from the communication program 113. For example, the emotion estimation program 114 detects average emotion of the other party during the entire video call as shown in FIG. 4. As another example, the emotion estimation program 114 may detect the emotion of the other party during a certain section of the video call as shown in FIGS. 5 and 6. As yet another example, the emotion estimation program 114 may detect the average emotion of the other party during the entire voice call as shown in FIG. 7. As another example, the emotion estimation program 114 may detect the emotion of the other party during a certain section of the voice call as shown in FIGS. 8 and 9. In so doing, the emotion estimation program 114 detects the emotion of the other party from the video and voice call data using the visual sample information and the voice sample information stored in the data storage 112.

The phone book management program 115 includes at least one software component for controlling to store the emotion of the other party, detected by the emotion estimation program 114, in the phone book. For example, the phone book management program 115 controls to store the emotion of the other party estimated by the emotion estimation program 114 in the phone book data of the other party of the phone book.

The phone book management program 115 includes a software component for providing a phone book service when a phone book execution event arises. For example, when the phone book execution event occurs, the phone book management program 115 provides a list of at least one phone book data including the emotional information. For example, in the phone book execution event, the phone book management program 115 may provide the list of the at least one phone book data. When any phone book data is selected in the phone book list, the phone book management program 115 may provide the selected phone book data including the emotional information.

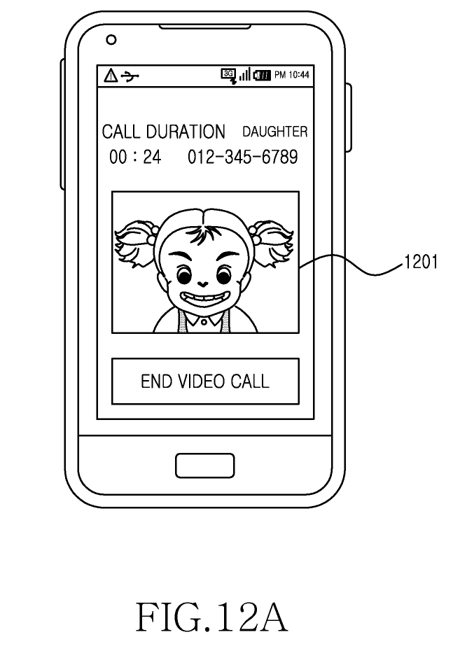

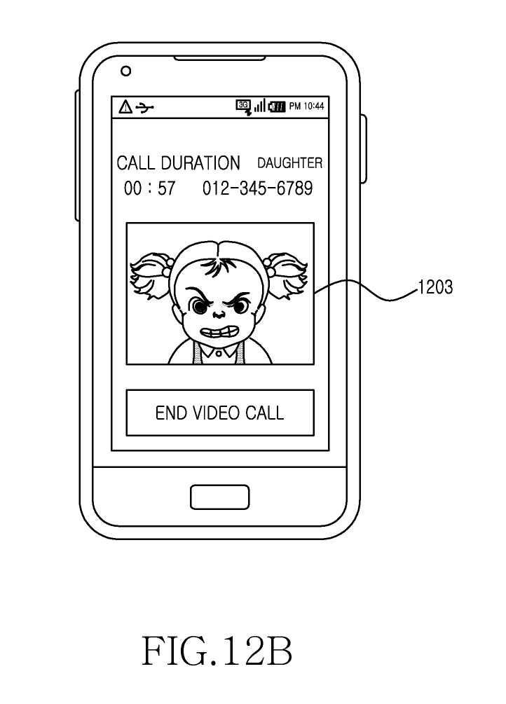

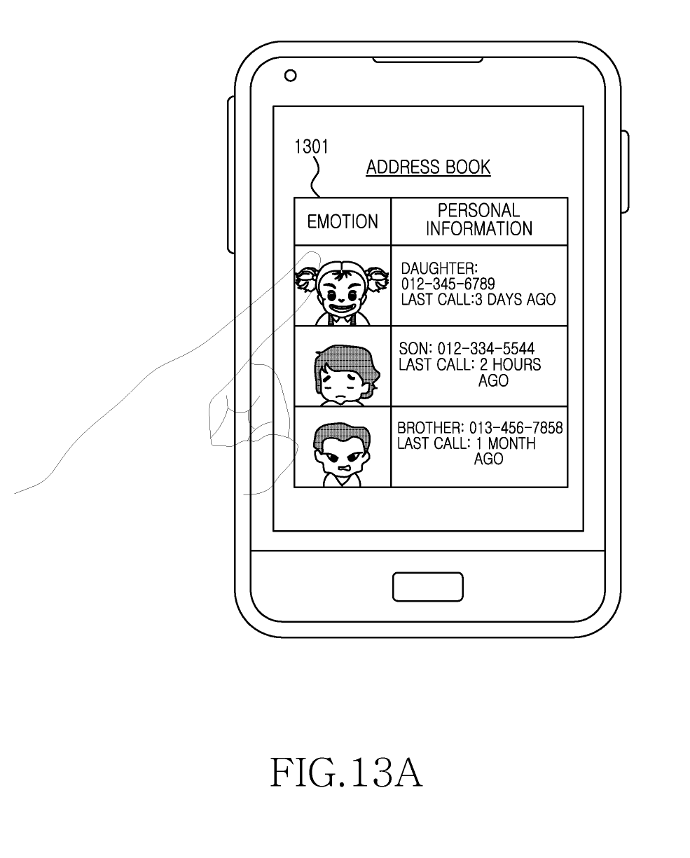

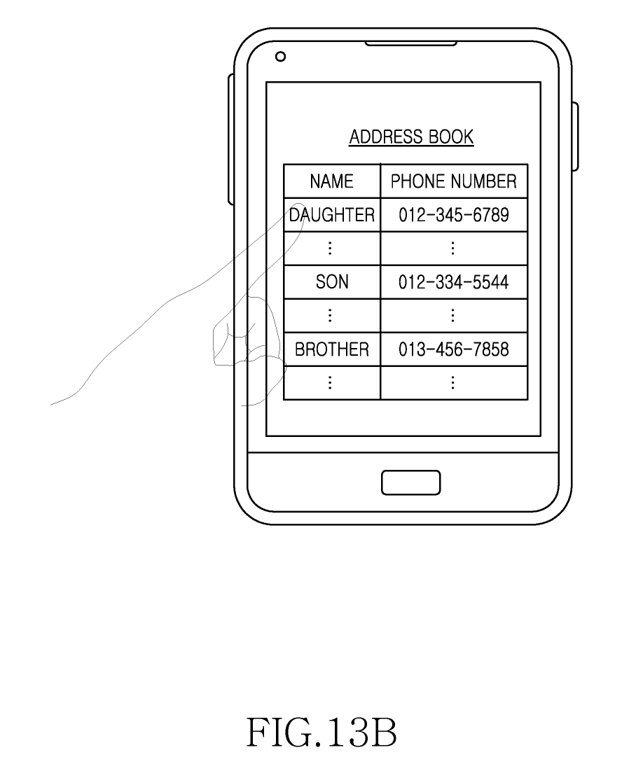

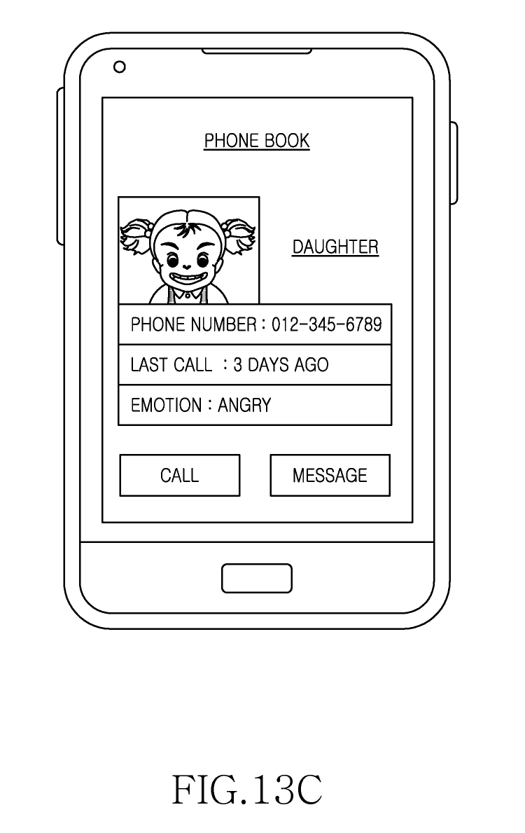

The graphical user interface program 116 includes a software component for displaying the phone book service including emotional information in the display 170. For example, when the phone book service is executed, the graphical user interface program 116 displays the phone book including emotional information 1301 in the display 170 as shown in FIG. 13A. In so doing, the phone book includes a name, a phone number, and the last call time. The graphical user interface program 116 displays a screen for the video call service in the display 170 as shown in FIGS. 12A and 12B.

The application program 117 includes a software component for at least one application program installed in the electronic device 100.

The processor unit 120 includes a memory interface 121, at least one processor 122, and a peripheral interface 123. Herein, the memory interface 121, the at least one processor 122, and the peripheral interface 123 of the processor unit 120 can be integrated onto at least one integrated circuit or embodied as separate components.

The memory interface 121 controls access of the component such as the processor 122 or the peripheral interface 123, to the memory 110.

The peripheral interface 123 controls connection of an I/O peripheral of the electronic device 100 and the processor 122 and the memory interface 121.

The processor 122 controls the electronic device 100 to provide various multimedia services using at least one software program. In so doing, the processor 122 controls to execute at least one program stored in the memory 110 and to provide a service according to the corresponding program.

The communication system 130 performs a communication function for voice communication and data communication. The communication system 130 may be divided into a plurality of communication submodules for supporting different communication networks. Herein, the communication networks include, but are not limited to, a Global System for Mobile Communication (GSM) network, an Enhanced Data GSM Environment (EDGE) network, a Code Division Multiple Access (CDMA) network, a Wideband-CDMA (W-CDMA) network, a Long Term Evolution (LTE) network, an Orthogonal Frequency Division Multiple Access (OFDMA) network, a wireless Local Area Network (LAN), a Bluetooth network, a Near Field Communication (NFC) network, and the like.

The audio processor 140 provides an audio interface between a user and the electronic device 100 through a speaker 141 and a microphone 142.

The camera system 150 captures and processes images such as moving picture data and still picture data.

The I/O controller 160 provides an interface between the I/O device such as display 170 and input device 180, and the peripheral interface 123.

The display 170 displays status information of the electronic device 100, a letter input by the user, a moving picture, a still picture, and the like.

The display 170 may be implemented using a touch screen. In this case, the display 170 provides touch information of the touch screen to the processor unit 120 via the I/O controller 160.

The input device 180 provides input data generated by a user's selection to the processor unit 120 via the I/O controller 160. For example, the input device 180 may include only a control button to control the electronic device 100. For example, the input device 180 may include a keypad for receiving input data from the user.

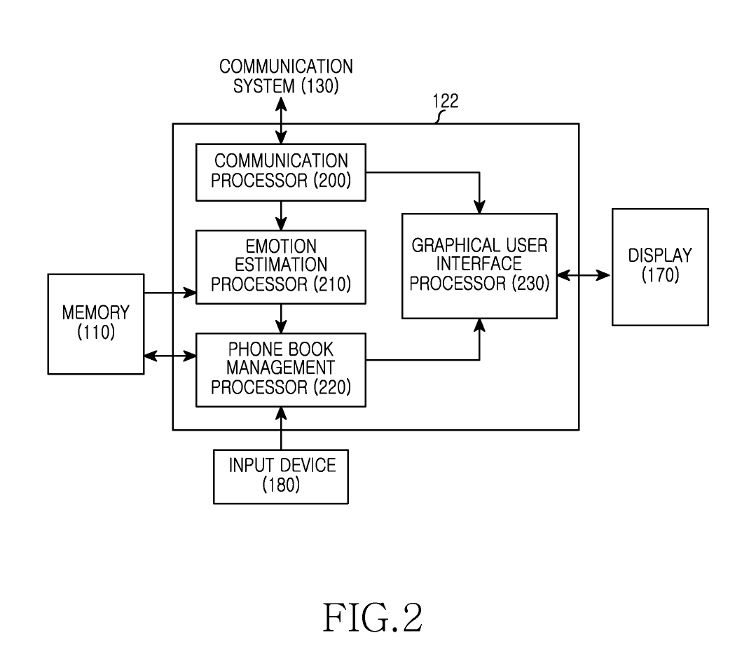

FIG. 2 is a block diagram of a processor according to an exemplary embodiment of the present invention.

Referring to FIG. 2, the processor 122 includes a communication processor 200, an emotion estimation processor 210, a phone book management processor 220, and a graphical user interface processor 230. In an exemplary implementation, the communication processor 200 is provided for executing the communication program 113, the emotion estimation processor 210 is provided for executing the emotion estimation program 114, the phone book management processor 220 is provided for executing the phone book management program 115, and the graphical user interface processor 230 is provided for executing the graphical user interface program 116.

The communication processor 200 receives call data from the other party by executing the communication program 113 of the program storage 111.

The emotion estimation processor 210 detects the emotion of the other party using the call data received from the communication processor 200 by executing the emotion estimation program 114 of the program storage 111. For example, the emotion estimation processor 210 detects the average emotion of the other party during the entire video call as shown in FIG. 4. As another example, the emotion estimation processor 210 may detect the emotion of the other party during a certain section of the video call as shown in FIGS. 5 and 6. As yet another example, the emotion estimation processor 210 may detect the average emotion of the other party during the entire voice call as shown in FIG. 7. As another example, the emotion estimation processor 210 may detect the emotion of the other party during a certain section of the voice call as shown in FIGS. 8 and 9. In so doing, the emotion estimation processor 210 detects the emotion of the other party from the video and voice call data using the visual sample information and the voice sample information stored in the data storage 112.

The phone book management processor 220 determines the emotional information to store in the phone book based on the emotion of the other party detected by the emotion estimation processor 210 by executing the phone book management program 115 of the program storage 111. For example, the phone book management processor 220 controls to store the emotion of the other party estimated by the emotion estimation processor 210 in the phone book data of the other party stored in the phone book.

The phone book management processor 220 executes the phone book management program 115 of the program storage 111 and provides the phone book service when the phone book execution event arises.

For example, when the phone book execution event occurs, the phone book management processor 220 provides the list of the at least one phone book data including the emotional information. In the phone book execution event, the phone book management processor 220 may provide the list of the at least one phone book data. When phone book data is selected from the phone book data list, the phone book management processor 220 may provide the selected phone book data including the emotional information.

The graphical user interface processor 230 displays the phone book service including the emotional information in the display 170 by executing the graphical user interface program 116 of the program storage 111. For example, in the phone book service, the graphical user interface processor 230 displays the phone book including the emotional information 1301 in the display 170 as shown in FIG. 13A. In so doing, the phone book includes the name, the phone number, and the last call time. The graphical user interface processor 230 displays the screen for the video call service in the display 170 as shown in FIGS. 12A and 12B.

In an exemplary implementation, the electronic device 100 includes the communication program 113, the emotion estimation program 114, the phone book management program 115, and the graphical user interface program 116 to provide the phone book service including the emotional information of the program storage 111. Hence, the electronic device 100 controls the processor 122 of FIG. 2 to run the program in the program storage 111 and to provide the phone book service including the emotional information.

Alternatively, the electronic device 100 may control to provide the phone book service including the emotional information using the processor 122 including the communication program 113, the emotion estimation program 114, the phone book management program 115, and the graphical user interface program 116. More specifically, the processor 122 of FIG. 2 may include information of the communication program 113, the emotion estimation program 114, the phone book management program 115, and the graphical user interface program 116.

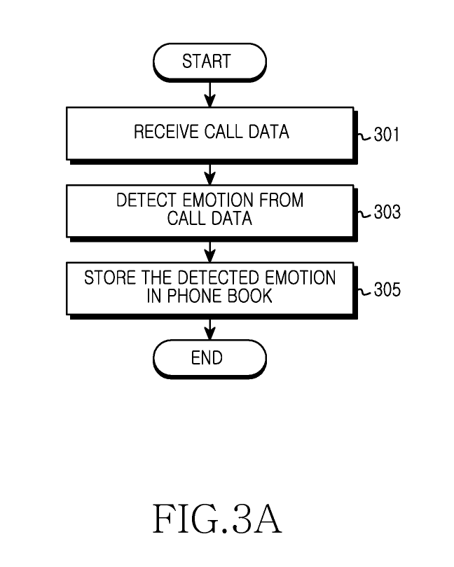

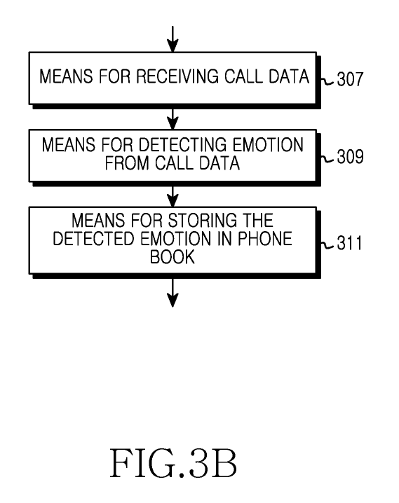

FIG. 3A is a flowchart of a method for storing emotional information in a phone book in an electronic device according to an exemplary embodiment of the present invention.

Referring to FIG. 3A, the electronic device receives call data from the other party in step 301. For example, in the video call service, the electronic device displays the video call data received from the other party of the video telephony in the display 170 as shown in FIGS. 12A and 12B. The call data may include only the voice data excluding the video data.

In step 303, the electronic device detects emotion of the other party using the call data received from the other party. For example, the electronic device detects the average emotion of the other party during the entire video call. For another example, the electronic device may detect the emotion of the other party during a certain section of the video call. For yet another example, the electronic device may detect the average emotion of the other party during the entire voice call. For another example, the electronic device may detect the emotion of the other party during a certain section of the voice call.

In step 305, the electronic device stores the detected emotion of the other party in the phone book data of the other party of the phone book. For example, the electronic device stores the emotion of the other party in the form of at least one of a captured view of the video call, a moving picture of a section of the video call, an emoticon, and a word. When the phone book data of the other party includes preset emotional information, the electronic device updates it with the detected emotion of the other party in step 303.

As above, the method for storing the emotional information in the phone book in the electronic device may include means for storing the emotional information in the phone book in the electronic device as shown in FIG. 3B.

FIG. 3B is a diagram of an electronic device for storing emotional information in a phone book according to an exemplary embodiment of the present invention.

Referring to FIG. 3B, the electronic device includes a first means 307 for receiving the call data, a second means 309 for detecting the emotion of the other party using the received call data, and a third means 311 for storing the detected emotion in the phone book.

The first means 307 receives the call data from the other party. For example, in the video call service, the first means 307 displays the video call data received from the other party of the video telephony in the display 170 as shown in FIGS. 12A and 12B. The call data may include only the voice data excluding the video data.

The second means 309 detects the emotion of the other party using the call data received at the first means 307. For example, the electronic device detects the average emotion of the other party during the entire video call. For another example, the electronic device may detect the emotion of the other party during a section of the video call. For yet another example, the electronic device may detect the average emotion of the other party during the entire voice call. For another example, the electronic device may detect the emotion of the other party during a section of the voice call.

The third means 311 stores the emotion of the other party detected by the second means 309 in the phone book data of the other party of the phone book. For example, the electronic device stores the emotion of the other party in the form of at least one of the captured view of the video call, the moving picture of a section of the video call, the emoticon, and the word. When the phone book data of the other party includes preset emotional information, the electronic device updates it with the detected emotion of the other party.

As above, the electronic device includes the means for storing the emotional information in the phone book. In so doing, the electronic device may unify the means for storing the emotional information in the phone book.

FIG. 4 is a flowchart of a method for storing emotional information in a phone book using video call data in an electronic device according to an exemplary embodiment of the present invention.

Referring to FIG. 4, the electronic device receives the video call data from the other party in step 401.

In step 403, the electronic device displays the received video call data. For example, the electronic device displays the video call data received from the other party in the display 170 as shown in FIGS. 12A and 12B.

In step 405, the electronic device determines whether a period of the emotion detection arrives. The emotion detection period can be preset or set by the user. When the emotion detection period for the video call data does not arrive yet, the electronic device receives the video call data in step 401.

When the emotion detection period arrives, the electronic device detects the emotion of the other party from the video call data in step 407. For example, when the other party makes a smiling face 1201 in the video call screen as shown in FIG. 12A, the electronic device estimates the emotion of the other party at “good” using the preset visual sample information. another example, when the other party makes an angry face 1203 in the video call screen as shown in FIG. 12B, the electronic device estimates the emotion of the other party at “angry” using the preset visual sample information.

In step 409, the electronic device determines whether the video call is ended. When the video call is not ended, the electronic device receives the video call data in step 401.

In contrast, when the video call ends, the electronic device determines the average emotion of the other party using the other party's emotions periodically detected during the video call in step 411.

In step 413, the electronic device stores the emotion of the other party in the phone book. For example, the electronic device stores the emotion of the other party in the form of at least one of the captured view of the video call, the moving picture of a section of the video call, the emoticon, and the word. When the phone book data of the other party includes the preset emotional information, the electronic device updates it with the detected emotion of the other party in step 411.

Next, the electronic device finishes this process.

FIG. 5 is a flowchart of a method for storing emotional information in a phone book using video call data in an electronic device according to an exemplary embodiment of the present invention.

Referring to FIG. 5, the electronic device receives the video call data from the other party in step 501.

In step 503, the electronic device displays the received video call data. For example, the electronic device displays the video call data received from the other party in the display 170 as shown in FIGS. 12A and 12B.

In step 505, the electronic device determines whether the period of the emotion detection arrives. The emotion detection period can be preset or set by the user. When the emotion detection period for the video call data does not arrive yet, the electronic device receives the video call data in step 501.

When the emotion detection period arrives, the electronic device detects the emotion of the other party from the video call data in step 507. For example, when the other party makes the smiling face 1201 in the video call screen as shown in FIG. 12A, the electronic device estimates the emotion of the other party at “good” using the preset visual sample information. For example, when the other party makes the angry face 1203 in the video call screen as shown in FIG. 12B, the electronic device estimates the emotion of the other party at “angry” using the preset visual sample information.

In step 509, the electronic device sets the detected emotion to the emotion of the other party. When a preset emotion of the other party exists, the electronic device updates it with the detected emotion of the other party of step 507.

In step 511, the electronic device determines whether the video call ends. When the video call is not ended, the electronic device receives the video call data in step 501.

In contrast, when the video call ends, the electronic device stores the set emotion of the other party in the phone book in step 513. For example, the electronic device stores the emotion of the other party in the form of at least one of the captured view of the video call, the moving picture of a section of the video call, the emoticon, and the word. When the phone book data of the other party includes the preset emotional information, the electronic device updates it with the set emotion of the other party of step 509.

Next, the electronic device finishes this process.

FIG. 6 is a flowchart of a method for storing emotional information in a phone book using video call data in an electronic device according to an exemplary embodiment of the present invention.

Referring to FIG. 6, the electronic device receives the video call data from the other party in step 601.

In step 603, the electronic device displays the received video call data. For example, the electronic device displays the video call data received from the other party in the display 170 as shown in FIGS. 12A and 12B.

In step 605, the electronic device determines whether the video call ends. When the video call is not ended, the electronic device receives the video call data in step 601.

In contrast, when the video call ends, the electronic device detects the emotion of the other party from the video call data of a certain section before the end of the video call in step 607. For example, when the other party makes the smiling face 1201 in the video call screen as shown in FIG. 12A, the electronic device estimates the emotion of the other party at “good” using the preset visual sample information. For example, when the other party makes the angry face 1203 in the video call screen as shown in FIG. 12B, the electronic device estimates the emotion of the other party at “angry” using the preset visual sample information. In so doing, the video call data of the certain section before the end of the video call can save the video call data of a reference section using a buffer of the electronic device during the video call. Herein, the certain section can be preset or set by the user.

In step 609, the electronic device stores the emotion of the other party in the phone book. For example, the electronic device stores the emotion of the other party in the form of at least one of the captured view of the video call, the moving picture of a section of the video call, the emoticon, and the word. When the phone book data of the other party includes the preset emotional information, the electronic device updates it with the detected emotion of the other party of step 607.

Next, the electronic device finishes this process.

Referring to FIGS. 4, 5, and 6, the electronic device detects the emotion of the other party using the video call data.

Alternatively, the electronic device detects the emotion of the other party using the voice call data.

FIG. 7 is a flowchart of a method for storing emotional information in a phone book using voice call data in an electronic device according to an exemplary embodiment of the present invention.

Referring to FIG. 7, the electronic device receives the voice call data from the other party in step 701.

In step 703, the electronic device outputs the voice call data received from the other party through the speaker 141.

In step 705, the electronic device determines whether the period of the emotion detection arrives. The emotion detection period can be preset or set by the user. When the emotion detection period for the voice call data does not arrive yet, the electronic device receives the voice call data in step 701.

When the emotion detection period arrives, the electronic device detects the emotion of the other party from the voice call data in step 707. For example, the electronic device detects words, accent, speed, and voice volume of the other party based on the voice call data. Next, the electronic device estimates the emotion of the other party using the preset voice sample information.

In step 709, the electronic device determines whether the voice call is ended. When the voice call is not ended, the electronic device receives the voice call data in step 701.

In contrast, when the voice call ends, the electronic device determines the average emotion of the other party using the emotions periodically detected during the voice call in step 711.

In step 713, the electronic device stores the determined emotion in the phone book. For example, the electronic device stores the emotion of the other party in the form of at least one of the emoticon and the word. For another example, when holding the video call data of the other party, the electronic device may store the emotion of the other party in the form of at least one of the captured view of the video call, the moving picture of a section of the video call, the emoticon, and the word. When the phone book data of the other party includes the preset emotional information, the electronic device updates it with the detected emotion of the other party of step 711.

Next, the electronic device finishes this process.

FIG. 8 is a flowchart of a method for storing emotional information in a phone book using voice call data in an electronic device according to an exemplary embodiment of the present invention.

Referring to FIG. 8, the electronic device receives the voice call data from the other party in step 801.

In step 803, the electronic device outputs the voice call data received from the other party through the speaker 141.

In step 805, the electronic device determines whether the period of the emotion detection arrives. The emotion detection period can be preset or set by the user. When the emotion detection period for the voice call data does not arrive yet, the electronic device receives the voice call data in step 801.

When the emotion detection period arrives, the electronic device detects the emotion of the other party from the voice call data in step 807. For example, the electronic device detects the words, accent, speed, and voice volume of the other party based on the voice call data. Next, the electronic device estimates the emotion of the other party using the preset voice sample information.

In step 809, the electronic device sets the detected emotion to the emotion of the other party. When the preset emotion of the other party exists, the electronic device updates it with the detected emotion of the other party of step 807.

In step 811, the electronic device determines whether the voice call ends. When the voice call is not ended, the electronic device receives the voice call data in step 801.

In contrast, when the voice call ends, the electronic device stores the set emotion of the other party in the phone book in step 813. For example, the electronic device stores the emotion of the other party in the form of at least one of the emoticon and the word. For another example, when holding the video call data of the other party, the electronic device may store the emotion of the other party in the form of at least one of the captured view of the video call, the moving picture of a section of the video call, the emoticon, and the word. When the phone book data of the other party includes the preset emotional information, the electronic device updates it with the set emotion of the other party of step 809.

Next, the electronic device finishes this process.

FIG. 9 is a flowchart of a method for storing emotional information in a phone book using voice call data in an electronic device according to an exemplary embodiment of the present invention.

Referring to FIG. 9, the electronic device receives the voice call data from the other party in step 901.

In step 903, the electronic device outputs the voice call data received from the other party through the speaker 141.

In step 905, the electronic device determines whether the voice call ends. When the voice call is not ended, the electronic device receives the voice call data in step 901.

In contrast, when the voice call ends, the electronic device detects the emotion of the other party from the voice call data of a certain section before the end of the voice call in step 907. For example, the electronic device detects the words, accent, speed, and voice volume of the other party based on the voice call data. Next, the electronic device estimates the emotion of the other party using the preset voice sample information. In so doing, the voice call data of the certain section before the end of the voice call can save the voice call data of a reference section using the buffer of the electronic device during the video call. Herein, the certain section can be preset or set by the user.

In step 909, the electronic device stores the emotion of the other party in the phone book. For example, the electronic device stores the emotion of the other party in the form of at least one of the emoticon and the word. For example, when holding the video call data of the other party, the electronic device may store the emotion of the other party in the form of at least one of the captured view of the video call, the moving picture of a section of the video call, the emoticon, and the word. When the phone book data of the other party includes the preset emotional information, the electronic device updates it with the detected emotion of the other party of step 907.

Next, the electronic device finishes this process.

In those exemplary embodiments, the electronic device stores the emotional information in the phone book.

Alternatively, the electronic device provides the phone book service.

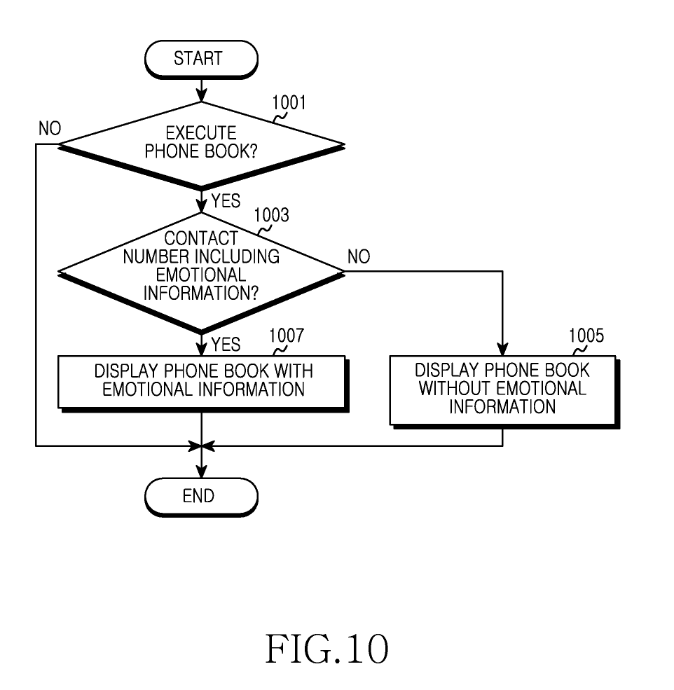

FIG. 10 is a flowchart of a method for providing a phone book service in an electronic device according to an exemplary embodiment of the present invention.

Referring to FIG. 10, the electronic device determines whether the phone book service is executed in step 1001. For example, the electronic device determines whether a phone book service menu is selected according to a user's manipulation. When the phone book service is not executed, the electronic device finishes this process.

When the phone book service is executed, the electronic device determines whether it holds a contact number including the emotional information in step 1003. For example, the electronic device determines whether the data storage 112 stores at least one contact number including the emotional information. When storing no contact number including the emotional information, the electronic device displays the phone book without the emotional information in step 1005. For example, the electronic device displays the phone book without the emotional information in the display 170 as shown in FIG. 13B. At this time, the phone book includes the number, the phone number, and the like.

In contrast, when storing the contact number including the emotional information, the electronic device displays the phone book with the emotional information in step 1007. For example, when the data storage 112 stores at least one contact number including the emotional information, the electronic device displays the phone book including the emotional information in the display 170 as shown in FIG. 13A. At this time, the phone book includes the number, the phone number, the last call time, the word indicating the emotion, and so on.

Next, the electronic device finishes this process.

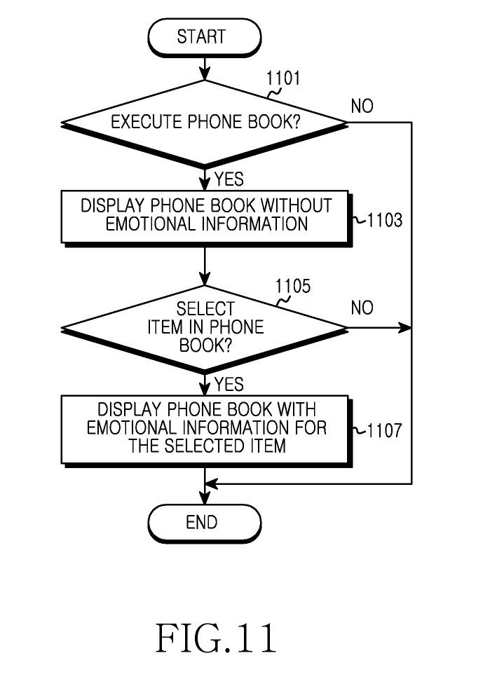

FIG. 11 is a flowchart of a method for providing a phone book service in an electronic device according to an exemplary embodiment of the present invention.

Referring to FIG. 11, the electronic device determines whether the phone book service is executed in step 1101. For example, the electronic device determines whether the phone book service menu is selected according to the user's manipulation. When the phone book service is not executed, the electronic device finishes this process.

When the phone book service is executed, the electronic device displays the phone book without the emotional information in step 1103. For example, the electronic device displays the phone book without the emotional information in the display 170 as shown in FIG. 13B. At this time, the phone book includes the number, the phone number, and the like.

In step 1105, the electronic device determines whether an item is selected in the phone book. For example, the electronic device determines whether the user's manipulation selects at least one item in the phone book service of FIG. 13B. When no item is selected in the phone book, the electronic device finishes this process.

In contrast, when an item is selected in the phone book, the electronic device displays the phone book including the emotional information for the selected item in step 1107. For example, the electronic device displays the phone book including the emotional information in the display 170 as shown in FIG. 13C. The phone book includes the name, the phone number, the last call time, and the word indicating the emotion.

Next, the electronic device finishes this process.

In the above exemplary embodiments, the electronic device detects the emotion of the other party and stores the detected emotion of the other party in the phone book. In so doing, it is assumed that the electronic device holds the phone book data relating to the other party. Without the phone book data of the other party, the electronic device may generate the phone book data of the other party so as to store the emotion of the other party.

As set forth above, since the electronic device stores the emotional information of the other party in the phone book, the electronic device user can capture the emotion of the other party by means of the phone book service including the emotional information and communicate with the other party by considering disposition of the other party.

It will be appreciated that embodiments of the present invention according to the claims and description in the specification can be realized in the form of hardware, software or a combination of hardware and software.

Any such software may be stored in a computer readable storage medium. The computer readable storage medium stores one or more programs (software modules), the one or more programs comprising instructions, which when executed by one or more processors in an electronic device, cause the electronic device to perform a method of the present invention.

Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention.

Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for providing a phone book service comprising emotional information in an electronic device, the method comprising:
receiving call data;
detecting an emotion of another party using the received call data; and
storing the emotion of the other party to phone book data of the other party in a phone book.

2. The method of claim 1, wherein the detecting of the emotion of the other party comprises:
detecting the emotion of the other party using at least one of video information and voice information of the received call data.

3. The method of claim 1, wherein the detecting of the emotion of the other party comprises:
detecting the emotion of the other party from the received call data at time intervals; and
determining the emotion of the other party using at least one emotion detected at the time intervals.

4. The method of claim 1, wherein the detecting of the emotion of the other party comprises:
detecting the emotion of the other party using a section in the received call data; and
determining the detected emotion as the emotion of the other party.

5. The method of claim 1, wherein the storing of the emotion in the phone book data comprises:
storing the emotion in the form of at least one of a captured view of a video call, a moving picture of a section of the video call, an emoticon, and a word.

6. The method of claim 1, further comprising, after storing the emotion in the phone book data:
when a first event arises, displaying a list of at least one phone book data comprising the emotional information.

7. The method of claim 1, further comprising, after storing the emotion in the phone book data:
when a first event arises, displaying a list of at least one phone book data; and
when any phone book data is selected in the phone book data list, displaying emotional information in the selected phone book data.

8. The method of claim 1, further comprising, after detecting the emotion of the other party:
determining whether phone book data of the other party exists; and
when the phone book data of the other party exists, storing the phone book data in the phone book data.

9. The method of claim 8, further comprising:
when the phone book data of the other party does not exist, generating phone book data of the other party.

10. The method of claim 1, wherein the storing of the emotion in the phone book data comprises:
determining whether the phone book data stores emotional information of the other party; and
when the emotional information of the other party is stored, updating the stored emotional information with the detected emotion of the other party.

11. An electronic device comprising:
one or more processors;
a memory; and
one or more programs, stored in the memory, configured for execution by the one or more processors,
wherein the one or more programs comprise instructions for receiving call data, for detecting an emotion of another party using the received call data, and for storing the emotion of the other party to phone book data of the other party in a phone book.

12. The electronic device of claim 10, wherein the instruction for detecting the emotion of the other party detects the emotion of the other party using at least one of video information and voice information of the received call data.

13. The electronic device of claim 11, wherein the instruction for detecting the emotion of the other party detects the emotion of the other party from the received call data at time intervals, and determines the emotion of the other party using at least one emotion detected at the time intervals.

14. The electronic device of claim 11, wherein the instruction for detecting the emotion of the other party detects the emotion of the other party using a section in the received call data, and determines the detected emotion as the emotion of the other party.

15. The electronic device of claim 11, wherein the instruction for storing the emotion in the phone book data stores the emotion in the form of at least one of a captured view of a video call, a moving picture of a section of the video call, an emoticon, and a word.

16. The electronic device of claim 11, further comprising, after storing the emotion in the phone book data:
an instruction for, when a first event arises, displaying a list of at least one phone book data comprising the emotional information.

17. The electronic device of claim 11, further comprising, after storing the emotion in the phone book data:
an instruction for, when a first event arises, displaying a list of at least one phone book data, and when any phone book data is selected in the phone book data list, displaying emotional information in the selected phone book data.

18. The electronic device of claim 11, the instruction further comprising, after detecting the emotion of the other party:
an instruction for determining whether phone book data of the other party exists,
wherein, when the phone book data of the other party exists, the detected phone book data is stored in the phone book data.

19. The electronic device of claim 18, further comprising:
an instruction for, when the phone book data of the other party does not exist, generating phone book data of the other party.

20. The electronic device of claim 11, wherein the instruction for storing the emotion in the phone book data determines whether the phone book data stores emotional information of the other party, and updates the stored emotional information with the detected emotion of the other party when the emotional information of the other party is stored.
